(19) United States
(12) Patent Application Publication
(10) Pub. No.: US 2026/0170395 A1
(43) Pub. Date: Jun. 18, 2026

(54) PREDICTIVE COMPONENT MANAGEMENT WITH AUTOMATED REPLACEMENT AND DISPOSAL DETERMINATIONS

(71) Applicant: HEWLETT PACKARD ENTERPRISE DEVELOPMENT LP, Spring, TX (US)

(72) Inventors: ABHISHEK MUKUNDKUMAR ACHARYA, Spring, TX (US); LOREDANA COPPA, Leixlip (IE)

(21) Appl. No.: 18/979,025

(22) Filed: Dec. 12, 2024

(51) Int. Cl. G06N 20/00; G06Q 10/0631

(52) U.S. Cl. CPC G06N 20/00; G06Q 10/06315

(57) ABSTRACT

Systems and methods are provided for monitoring operations performed by a device component to help implement predictive component management with automated replacement and disposal determinations for the device component. For example, the system may monitor operations performed by the component through a first time (e.g., using sensors, operational logs, etc.). The system may inspect the physical parameters of the device component, with analytics from a machine learning model to help determine a predicted value of the device component. In response to the predicted value, the system may initiate an action associated with the predicted value.

### BACKGROUND

In the fast-evolving technology sector, hardware components in the information technology (IT) space, such as servers, storage systems, memory devices, processors, and networking equipment rapidly become obsolete. For example, hardware components generally progress through a lifecycle that corresponds with a series of stages from conception to retirement. The components are designed and manufactured, involving sourcing materials, assembling components, and quality assurance testing to ensure the product meets specifications. The components are then introduced to a customer site, where they are used for various operations. As these hardware components are used over time, they eventually become obsolete or irrelevant, or new hardware is implemented and installed at the site to correlate with advances in the technology. In some examples, the technology advances so fast that newer/more powerful hardware components are needed quicker, causing the lifecycle for older hardware, from conception to retirement, to be become shorter.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates a computing component for implementing predictive component management with automated replacement and disposal determinations, in accordance with some examples described herein.

FIG. 2 illustrates a computing platform configured to determine a predicted adjustment of operations for a device component, in accordance with some examples described herein.

FIG. 3 is an illustrative example of a predicted adjustment of operations for a device component, in accordance with some examples described herein.

FIG. 4 is an illustrative process for initiating actions, in accordance with some examples described herein.

FIG. 5 is an illustrative process for evaluating computing components for predictive component management, in accordance with some examples described herein.

FIG. 6 illustrates a computing component that may be used to implement predictive component management with automated replacement and disposal determinations, in accordance with various examples of the disclosed technology.

FIG. 7 is a computing component that may be used to implement examples of the disclosed technology.

The figures are not exhaustive and do not limit the present disclosure to the precise form disclosed.

### DETAILED DESCRIPTION

As noted above, hardware components can quickly become obsolete or irrelevant as technology continues to improve. For example, the hardware components may decline (with respect to other, newer components) due to technological advancements or changing consumer preferences, which causes device components to be recycled, replaced, or upgraded to meet the needs of the current technological demands. Traditional component lifecycle management may simply dispose of a device component at a particular time, which may lead to inefficient resource usage, increased carbon footprint costs, and greater environmental impact.

Examples of the disclosed technology may comprise a system that monitors operations performed by a device component or part (used interchangeably) to help implement predictive component management with automated replacement and disposal determinations for the device component. “Replacement” may comprise upgrading, downgrading, or otherwise removing the part from a customer site and replacing it with a different part. “Disposal” may comprise removing the part from the customer site without replacing it, and reusing or recycling the part at another location or for another purpose. In some examples, disposal can be subsequent to a replacement, where the replaced device is not in use and can be disposed.

Various examples are described throughout the disclosure. For example, the system may monitor operations performed by a device component (e.g., using sensors, operational logs, etc.). The operations may be stored as time series data associated with the monitoring and may vary based on the device component being monitored. For example, when the device component is a computer processor unit (CPU) or graphics processor unit (GPU), the utilization of the CPU or GPU may be determined. When the device component is memory, the memory usage may be determined. The time series data may be provided as input to a first machine learning model, with output of the first machine learning model comprising a predicted adjustment of the operations performed by the device component at some future time (e.g., deterioration of the component, hardware failure, inefficiencies in CPU utilization and memory usage, etc.).

The system may additionally determine ownership of the computing component. The ownership determination may be initiated in response to the predicted adjustment of the operations exceeding a threshold value (e.g., predicted operations performed at the future time). For example, the system can determine whether the ownership of the device component is associated with a customer user and the form of payment (for the equipment) or lease of the component (lease up front or via a financing option). When the device component is unowned, the device component may be associated with an ongoing payment obligation to a financing entity, rented, or borrowed for a duration of time. In response to the device component being unowned, the system may initiate a first action for the device component that is associated with the monitoring and the predicted adjustment of the operations (e.g., transmitting a notification regarding replacement the device component or tuning settings of the device component).

The system may inspect current physical parameters or historical data of the device component. In some examples, the physical parameters of the device component may be generated from an equipment assessment process called Technology Renewal Processing (TRP) that is conducted before the component is replaced or disposed. The equipment assessment process may inspect the device component at the originating location of the device (e.g., by traveling to the customer's building), through a remote visual assessment (e.g., transmitted images or streaming data of the device), or by transporting the device to a determined location for an assessment of its physical components in real-time.

In response to the ownership of the device component being owned (e.g., not rented, financed, etc.), features of the physical parameters of the device component may be provided to a second machine learning model. Output from the second machine learning model may comprise a predicted value of the device component.

In response to the predicted value, the system may initiate a second action associated with the predicted value. Various actions are considered with examples of the system described herein. For example, the first action (associated with the device component being unowned) may comprise transmitting a notification regarding replacing the device component or tuning settings of the device component (e.g., to improve the declining abilities of the device component that is identified through monitoring). The second action (associated with the predicted value) may comprise replacing the device component with a new part (e.g., adding faster processor or new memory to a server/blade) or replacing the device component with a pre-owned part (e.g., identifying a currently-owned component that can be repurposed for the device component). In other examples, the second action may comprise disposing of the component. Once a disposal is determined, the second action may recommend initiating a sales request or automatically initiating a sales request. The sale can be initiated through various channels, including through a sales broker, a wholesale or resale marketplace, or direct to a second customer/user. In some examples, the second action can recommend disposing of the component from the current customer/user by recommending to initiate a sales request or automatically initiating a sale of the component to a second customer/user.

Technical improvements are realized throughout the disclosure. For example, the system may implement real-time data analytics with predictive modeling to make informed decisions regarding the replacement and disposal of the device component, thus improving future technical operations and removing excessive data transmissions throughout the networks. When the system determines to replace the existing component with a pre-owned part, the process can help reduce the carbon footprint attributed to the device component, which can help reduce overall carbon generated by the implemented system. Furthermore, the use of real-time data may reduce delays and potential inaccuracies in disposing of device components, since the distributed and disparate data sources can fluctuate in real-time and drastically adjust the final determination of disposal or replacement of the device component in accordance with the data.

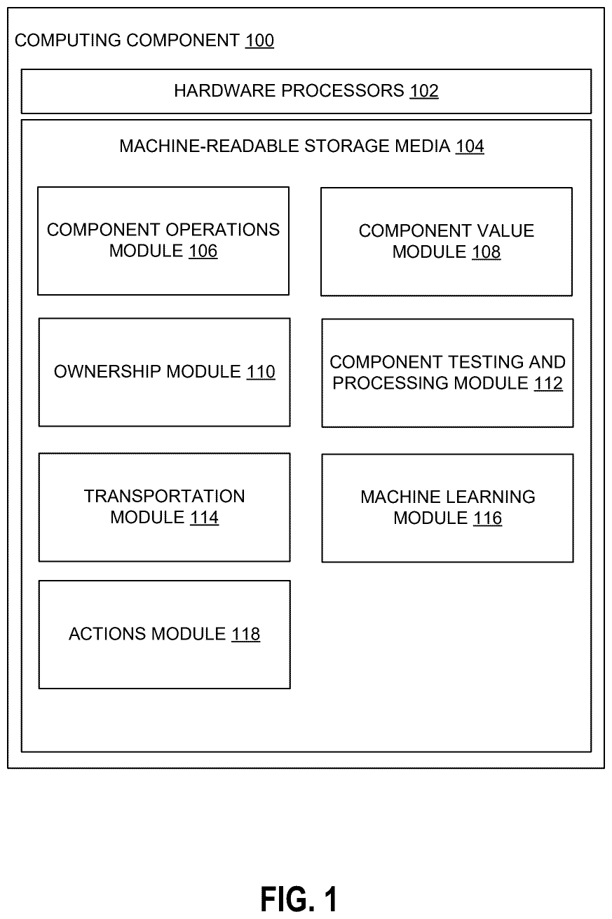

FIG. 1 illustrates a computing component for implementing predictive component management with automated replacement and disposal determinations, in accordance with some examples described herein. Computing component 100 is illustrated. Computing component 100 may be, for example, a server computer, a controller, or any other similar computing component capable of processing data.

Computing component 100 may communicate with other devices in a network, including devices at remote geographical sites, some of which may be helping to identify component operations, value, ownership, and other information that may contribute to the replacement or disposal of the component. The network may be a public or private network, such as the Internet, or other communication network to allow connectivity among various the sites. The network may include third-party telecommunication lines, such as phone lines, broadcast coaxial cable, fiber optic cables, satellite communications, cellular communications, and the like, and may include any number of intermediate network devices, such as switches, routers, gateways, servers, and/or controllers.

Computing component 100 includes hardware processor 102 and machine-readable storage medium 104. Machine-readable storage medium may comprise various modules configured with machine-readable instructions executed by processor 102, including component operations module 106, component value module 108, ownership module 110, component testing and processing module 112, transportation module 114, machine learning module 116, and actions module 118.

Hardware processor 102 may be one or more central processing units (CPUs), graphics processing units (GPUs), semiconductor-based microprocessors, and/or other hardware devices suitable for retrieval and execution of instructions stored in machine-readable storage medium 104. Hardware processor 102 may fetch, decode, and execute instructions to control processes or operations associated with the various modules illustrated herein. As an alternative or in addition to retrieving and executing instructions, hardware processor 102 may include one or more electronic circuits that include electronic components for performing the functionality of one or more instructions, such as a field programmable gate array (FPGA), application specific integrated circuit (ASIC), or other electronic circuits.

Machine-readable storage medium 104, may be any electronic, magnetic, optical, or other physical storage device that contains or stores executable instructions. Thus, machine-readable storage medium 104 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 104 may be a non-transitory storage medium, where the term “non-transitory” does not encompass transitory propagating signals.

Component operations module 106 is configured to monitor operations performed by a device component (e.g., using sensors, operational logs, etc.). The operations may be stored as time series data associated with the monitoring and may vary based on the device component being monitored. For example, when the device component is a computer processor unit (CPU) or graphics processor unit (GPU), the utilization of the CPU or GPU may be determined through the first time. When the device component is memory, the memory usage may be determined. The time series data, which is collected up to and including a first time, may be provided as input to a first machine learning model, as implemented with machine learning module 116. The output of the first machine learning model may comprise a predicted adjustment of the operations performed by the device component at a second time (e.g., deterioration of the component, hardware failure, inefficiencies in CPU utilization and memory usage, etc.).

In some examples, the operations are performed by the device component comprise computer processor unit (CPU) or graphics processor unit (GPU) utilization up to the first time. In other examples, the operations may be performed by the device component comprise memory usage up to the first time.

Component value module 108 is configured to determine the predicted remarketing or resale value of the device component at a point of time (e.g., separate from the initial prediction of the end of life of the device). For example, the value of the device component at a particular point in time may correspond with a wholesale value, retail value, sticker price, advertised price, remarketing value, resale value, or other value that an entity is willing to pay to acquire the device component.

The determined value of the device component may be used during training of the second machine learning model to adjust the weights, biases, features (e.g., by feature tuning), and other technical components of the second machine learning. Component value module 108 may determine the predicted value based on the training process that utilizes historical data of similar device components to predict the future value of the device component, and ultimately determine a replacement or disposal determination for the device component.

In some examples, the value of the device component may correspond with a device type. For example, for whole systems (e.g., servers, gateways, switches, etc.), the value of the device component may be identified by an end date of support (e.g., higher value with more support time remaining or higher value with more scarcity), the value corresponding to the number of users that are required to use the device component (e.g., locked into a legacy device component absent a newer model or version), or the value associated with the market conditions (e.g., supply and demand). In another example, for parts of whole systems (e.g., memory, processors, bolts, etc.), the value of the device component may be identified by a demand for the part being installed in other device components (e.g., the scarcity of a GPU), the cross-compatibility of the part to work in other device components, and the cost to transport the device component to a second location to install it in the secondary device (e.g., determined by transportation module 114).

In some examples, the value of the device component may be associated with current features of the device component, including age, brand/model, end of support date, number of customers currently using similar device components (e.g., cross-compatibility), number of customers that are required to continue using the component in their computing environment (e.g., difficulty to migrate to the new version), market conditions (e.g., supply/scarcity on the secondary market, average price exceeding a threshold value on the secondary market, etc.), or other factors that may affect the value of the component.

In some examples, the value of the device component may be affected by historical data, including supply of devices with the same component specifications (e.g., CPU, RAM, storage, GPU, brand, age), historical sale price, condition of the component and its effect on resale (e.g., new, used, refurbished), and market trends (e.g., seasonality, demand fluctuations). Other supply and demand factors may adjust the value of the device component as well.

In some examples, the value of the component may be affected by the owner of the component. For example, when the component is leased, the value of the component may be determined when the timeframe of the lease is complete (e.g., at some time in the future).

Ownership module 110 is configured to determine ownership of the computing component. For example, the device component may be unowned or owned. The determination of ownership may be identified from a data store that associates a particular device component with the status of the ownership, owner's information, location of the device component, or other information. The ownership determination may be initiated in response to the predicted adjustment of the operations exceeding a threshold value at the second time (e.g., as determined by machine learning module 116).

The ownership of the device component may be associated with a customer user that paid for the equipment up front or via a financing option. When the ownership of the device component is unowned at a first time, the device component may be associated with an ongoing payment obligation to a financing entity, rented, or borrowed for a duration of time, causing the device to be unowned by the customer user.

Other examples may be associated with a device component that is unowned. For example, the component may be leased (e.g., available for use without ownership). In another example, an entity other than the customer user may be the owner of the component and a debt may be owed to transfer the ownership to the customer user. This instance may cause the component to be unowned by the customer user as well.

In response to a determination that the device component is unowned (by ownership module 110), a first action may be initiated (by actions module 118). The first action may include transmitting a notification regarding replacing the device component.

Ownership module 110 is also configured to determine that the device is owned. In response to the ownership of the device component being owned (e.g., not rented, financed, etc.), features of the physical parameters of the device component may be determined or compared (by component testing and processing module 112).

Component testing and processing module 112 is configured to determine physical parameters of the device component. The physical parameters of the device component may be generated from an equipment assessment process at a technology renewal processing (TRP) that is conducted between the first time and the second time.

The physical parameters of the device component may be determined by analyzing the device component. The analysis may be performed virtually, on the same site where the device is located or at a separate site, or the component may be transferred for technology renewal processing (TRP). The analysis may be performed by a human that provides input to component testing and processing module 112 or via an automated process that inspects the component (e.g., image or video computational analysis). The physical inspection of the component may be stored as physical parameters of the device component in a data store.

In some examples, the physical parameters may identify whether the device component is operational, non-operational, or damaged. For example, component testing and processing module 112 may identify that the component is not functioning in its current state, yet may become functioning by replacing a sub-component (e.g., battery, processor in a server, power supply, etc.). In another example, component testing and processing module 112 may identify that the component is damaged in its current state (e.g., cosmetic or extensive) on a scale or range of values. The correlation of the damage may be adjusted based on the scarcity of the device component (e.g., if the component is scarce, it may still be valuable on the resale market).

In some examples, component testing and processing module 112 may inspect the physical parameters of the device component and compare it with historical data about the device. For example, the historical data may comprise a detailed list of all the component identifiers and quantities of components needed to make the device component. In some examples, the historical data includes a list of the raw materials, parts, and subassemblies needed to manufacture the device component.

Transportation module 114 is configured to determine a threshold value of transporting the device component from a first location to a second location. For example, the first location may be a location associated with the customer user or owner of the device component, and the second location may be associated with the TRP (for inspection and determination of the physical parameters) or the ultimate sales location (e.g., wholesaler or customer reseller purchaser).

The transportation costs may affect the action taken for the device component. For example, the cost of transporting the device component may reduce the predicted value of the device component. The second machine learning model may adjust the weights/biases during the model training process that can reduce the predicted value of the device component to account for the increased cost in transporting the component. In some examples, the transportation cost may be negligible in the overall value of the component. For example, the device component may have a same model, year, and component type as several other device components (e.g., with cross-compatibility to other device components) that are available from different locations. The cost to transport the device component may be less than a set of device components that are scarcer in terms of the same model, year, and component type.

Other transportation cost considerations may affect the predicted value determined by the second machine learning model and also affect the action recommended (e.g., in response to the output generated by the second machine learning model). For example, when the transportation cost exceeds a first threshold value and the predicted resale value of the device component fails to exceed a second threshold value, the action may correspond with recycling the device component. When the transportation cost is removed, like when a third party entity or the customer/user is paying the cost of the transportation, the predicted value of the component may outweigh the transportation cost and the action may correspond with transporting the device component to reuse it at a different location. These considerations can be used to adjust the weights/biases in the machine learning model to predict the estimated cost/value of the device component.

The transportation cost may be combined with a processing cost at the Technology Renewal Processing (TRP) (e.g., by component testing and processing module 112). For example, a first cost may be identified to transport the device component from the customer's location to the TRP. Once the device is at the TRP, a second cost may be identified to test, clean, and process the device component for reuse by a different entity.

The transportation cost may be reduced when multiple device components can be combined in a single shipment. For example, a first cost may be identified to transport a first device component from the customer's location to the TRP and a second cost may be identified to transport a second device component from the customer's location to the TRP. When the two device components are identified to work together (e.g., memory, processor, or other hardware components), the components may be aggregated in a single transportation cost as forming a single device.

Machine learning module 116 is configured to receive first time series data at a first machine learning model, where output of the model comprises a predicted adjustment of the operations performed by the device component at a second time.

The first machine learning model may be trained to determine a predicted adjustment of the operations performed by the device component. For example, test data may be provided to the machine learning model that includes features related to deterioration of similar device components (e.g., environmental conditions, usage patterns, maintenance records). The data may be labeled to indicate the state of deterioration or other adjustments to the operations of the device components (e.g., timestamps of failure, condition ratings) and cleaned (e.g., remove duplicates). The training process may comprise feature engineering to identify relevant features in the data that could influence the adjustment in operation of the device component. Once the features are identified, the process may normalize the features on a standardized scale and provide the training data with the feature selection to first machine learning model.

The first machine learning model may correspond with various algorithms, including linear regression, decision trees, random forests, or neural networks. The training process may implement hyperparameter tuning (e.g., Grid Search or Random Search) to optimize the model parameters and evaluate the accuracy of the model in determining the prediction (e.g., using RMSE or MAE, or for classification, accuracy and F1-score). The predictions/output may be interpreted using a secondary training process, including SHAP (SHapley Additive exPlanations) or LIME (Local Interpretable Model-agnostic Explanations) to interpret the model predictions.

In response to training the model using the training data, the first time series data may be provided as input to the trained model during an inference phase executed after the training phase. The inference phase may generate the predicted adjustment of the operations performed by the device component. The predicted adjustment of the operations performed by the device component may correspond with operations that the device component is predicted to execute/perform at a second time.

In some examples, the predicted adjustment of the operations (determined from the first machine learning model) may be compared with a threshold value. The threshold value may be based on historical data, industry standards, expert knowledge, or other critical level of deterioration or other adjusted operational value. In some examples, the threshold value is a specific value or relative (e.g., a percentage increase from a historical value). In some examples, the threshold value may be based on a binary classification (e.g., “deteriorated” if the prediction exceeds the threshold value and “not deteriorated” otherwise).

When the predicted adjustment of the operations exceeds the threshold value, the system may determine ownership of the device component at the first time by ownership module 110. In other examples, the ownership of the device component may be determined without or absent the determination of the threshold value or any predicted adjustment to the operations.

Machine learning module 116 is also configured to implement a second machine learning model, where output of the second machine learning model comprises a predicted value of the device component. For example, the predicted value may correspond with a market price, a resale value, or an estimated worth based on specific features of the device component.

The second machine learning model may be trained to determine a predicted value (e.g., with component value module 108). For example, test data may be provided to the machine learning model that includes features related to the value of similar device components, including age, brand/model, end of support date, number of customers currently using similar device components, number of customers that are required to continue using the component in their computing environment (e.g., difficulty to migrate to the new version), market conditions (e.g., supply on the secondary market, average price exceeding a threshold value on the secondary market, etc.), or other factors that may affect the value of the component. In some examples, the training data may include historical data on device component sales wholesaler or customer, including component specifications (e.g., CPU, RAM, storage, GPU, brand, age), sale price, condition of the component (e.g., new, used, refurbished), and market trends (e.g., seasonality, demand fluctuations). Other historical data may be utilized as well (e.g., internal data).

The training data may be labeled to indicate the final value that the component is resold (e.g., as a dollar value or range of values) and cleaned (e.g., remove improper duplicates in the data). In some examples, the value is associated with a third time frame that fluctuates based on the correlation of the training data to the final value of the component. The training process may comprise feature engineering to identify relevant features in the data that could influence the final value of the device component. Once the features are identified, the process may normalize the features on a standardized scale and provide the training data with the feature selection the second machine learning model.

The second machine learning model may correspond with a regression model to predict the predicted value (e.g., as a continuous value/variable). The regression model may comprise, for example, linear regression, decision trees, random forest, gradient boosting (XGBoost, LightGBM), or neural networks (for complex relationships). The training process may implement hyperparameter tuning (e.g., Grid Search or Random Search) to optimize the model parameters and evaluate the accuracy of the model in determining the predicted value (e.g., using RMSE or MAE, or for classification, accuracy and F1-score). The predictions/output may be interpreted using a secondary training process, including SHAP (SHapley Additive exPlanations) or LIME (Local Interpretable Model-agnostic Explanations) to interpret the model predictions.

In response to training the model using the training data, the second time series data may be provided as input to the trained second model during an inference phase executed after the training phase. The inference phase may generate the predicted value of the device component. The predicted value of the device component may correspond with an estimate of the value of the device component in its resale to a wholesaler, customer, or resale marketplace at a future time.

Actions module 118 is configured to determine various actions associated with the computing device. The actions may be initiated in association with the initiating with the predicted value of the device component or ownership of the device component.

For example, the first action (associated with the device component being unowned) may comprise transmitting a notification regarding replacing the device component or tuning settings of the device component (e.g., to improve the declining abilities of the device component that is identified through monitoring). In some examples, the first action associated with the monitoring comprises restarting or tuning settings of the device component.

The second action (associated with the predicted value) may comprise replacing the device component with a new part (e.g., adding faster processor or new memory to a server/blade or replacing the component with the same model/type of component that is not damaged) or replacing the device component with a pre-owned part (e.g., identifying a currently-owned component that can be repurposed for the device component). In some examples, the second action comprises transmitting a recommendation to order a new device component, or actually initiating an order for a new device component (e.g., through an online ordering system).

The second action may initiate disposal of the device component. For example, the second action may initiate a recycling process of the device component. In some examples, the second action may comprise transmitting a recommendation or initiating a request to sell the device component. In other examples, the second action may comprise disposing of the component by initiating a sales request to a broker or wholesaler for the device component that offers the device component via a resale marketplace, or disposing of the component by initiating a sales request to customer that directly uses the device component.

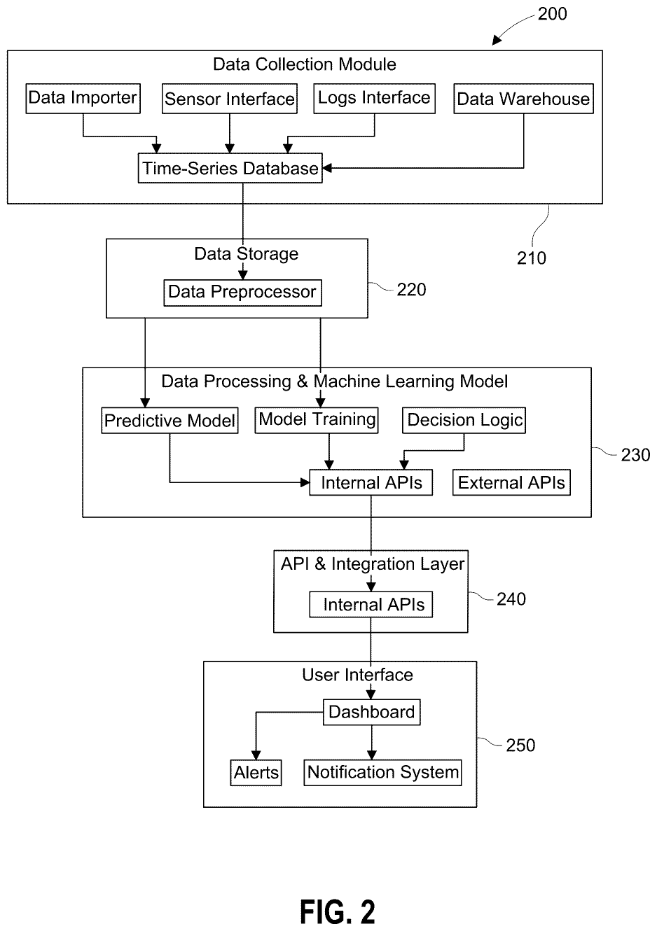

FIG. 2 illustrates a computing platform configured to determine a predicted adjustment of operations for a device component, in accordance with some examples described herein. In example 200, a computing platform is provided. The computing platform may be configured to determine a predicted adjustment of operations for a device component.

At block 210, a data collection module is illustrated. The module may receive time series data in real-time from multiple data sources, including a data importer, sensor interface, device log interface, or data warehouse to create a unified dataset. For example, the time series data may comprise device component usage data (e.g., server, memory, etc.) and market trends.

At block 220, the data from the time series database is provided to a data pre-processor module. The data pre-processor module may transform the raw data into a clean and usable format for input to the machine learning model. For example, during data cleaning, the pre-processor module may identify and correct errors, handle missing values, and remove duplicates in the data. In some examples, the pre-processor module may scale, normalize, or encode the data, or implement dimensionality reduction or feature selection.

At block 230, a machine learning model module is illustrated. The module may process the data received from block 220 and provide it as input to a ML model. In some examples, the data may be provided as input to train a ML model. Training may adjust weights and biases of the ML model to predict the end of life of a device component, predict a value of the device component at a particular time using historical data, or determine actions. Once the ML model(s) are trained, the data may be provided to a predictive model for inference. The training process for the ML model, the predictive model, and decision logic related to the ML model(s) are accessible via internal APIs within the system. In some examples, external ML models may be accessible via external APIs from the system.

At block 240, an integration layer is illustrated. In the integration layer, the system may provide access to a combined set of modules. The internal APIs that are implemented to access the integration layer may be accessible via an interface.

At block 250, a decision-making interface is illustrated. The interface may provide recommendations/actions that are determined by the ML models. For example, the interface may provide a recommendation for the user to dispose of the device component by repurposing, reselling, or recycling the device component. Other actions are described throughout the disclosure.

In some examples, the ML model(s) may be executed for a continuous learning process. The continuous learning process may implement subsequent training of the ML model. In some examples, the process may execute the training to update the ML model with new data for improved accuracy.

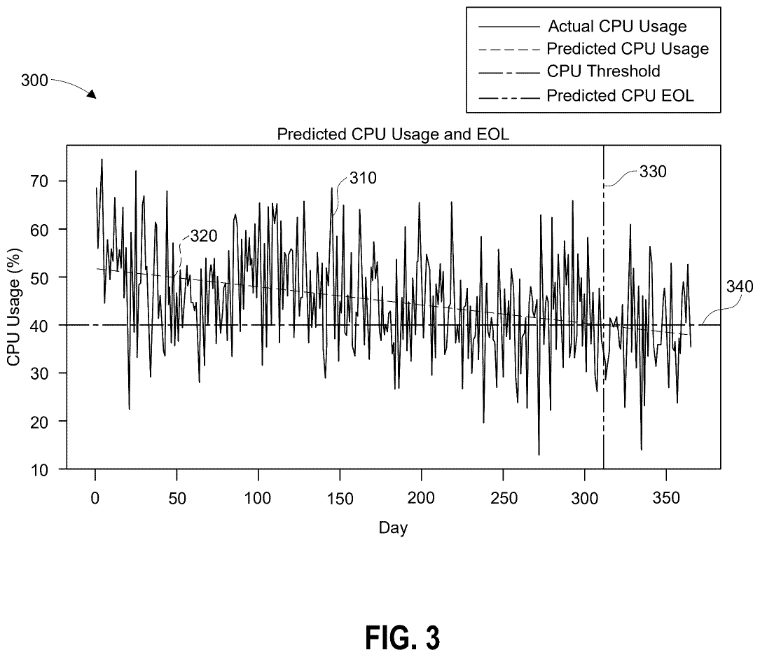

FIG. 3 is an illustrative example of a predicted adjustment of operations for a device component, in accordance with some examples described herein. In example 300, the system may monitor and predict adjustments to the operations of the computing component. The system may correspond with various systems comprising a processor and memory components, including computing component 100 illustrated in FIG. 1.

At block 310, operations performed by the device component may be monitored up to a first time. In this example, the operations correspond with CPU usage over time period. The first machine learning model may be trained to identify the predicted adjustment in the CPU usage over time, as illustrated at block 320. The determination of the operational ability of the device component is also identified, including the predicted end-of-life at block 330 and a minimum threshold value for the operational parameter at block 340, identified as the CPU usage in this example.

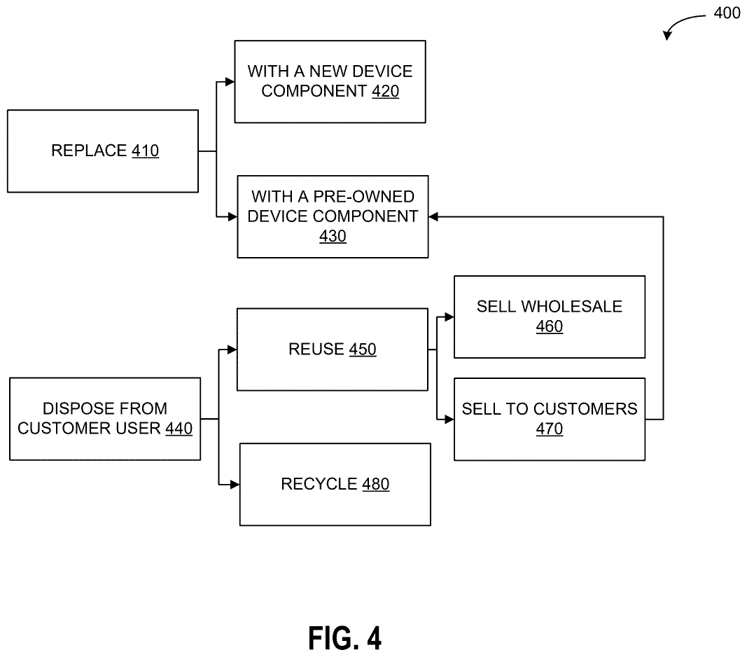

FIG. 4 is an illustrative process for initiating actions, in accordance with some examples described herein. In example 400, the process may identify actions to take on the device component. In some examples, the action may correspond with either the first action or the second action and in response to identifying the ownership of the device component at the time of the analysis/action (e.g., is owned by a customer user, or otherwise not leased/unowned). The action may be identified and initiated by a computing component, including computing component 100 illustrated in FIG. 1.

At block 410, the action determined is to replace the device component (e.g., upgrade, downgrade, or otherwise remove the current component and provide a different one). In some examples, the determination to replace the device component may help alleviate the declining operations that are detected the system. In some examples, the output of the first machine learning model comprising the predicted adjustment of the operations may correspond with a threshold value that is exceeded and used to determine that the device component should be replaced.

At block 420, the action determined to replace the device component includes removing the current device component and providing a new device component as a replacement. For example, the determination to replace with a new device component may be implemented when there are no preowned or used device components available. The identification of the device component to replace may be associated with the declining operations identified by the device component, or through identification of the output of the first machine learning model that associates the declining operations with the device that is causing the declining operations.

At block 430, the action determined to replace the device component includes removing the current device component and providing a different pre-owned device component in its place. In some examples, the determination to replace the device with a pre-owned or used components may be associated with an identification of the needed device component that is advertised or otherwise listed as available in a data store of available, used components.

In some examples, the disposal of the device component can include a refurbishment, by removing the device component from the customer location and preparing it for use by a different entity or for a different purpose. The refurbishment can include sanitizing and preparing the device to be used as a replacement, pre-owned part.

The replacement can include an older generation model, newer generation model, or the same generation model. For example, the operational abilities of the device component may be declining for various reasons, but the fundamental capabilities of the device component may still align with the needs of the system in place at the customer location. In this case, the same model/type of device component can be used to replace the current device component.

At block 440, the action determined is to dispose of the device component from the customer user. The disposal of the device component may initiate a process to place the device component into various existing programs. The existing programs may identify, for example, methods to dispose of the device component. These methods may include a recycling program or a reuse program that provides the device component to a user other than the customer user.

At block 450, the action determined is to dispose the device component by providing it to a different entity. The available entities may comprise, for example, wholesalers or brokers, or other customer users.

At block 460, the disposal may direct the device component to a wholesaler or broker. The identification of the wholesaler or broker may be based on various parameters and in comparison with other identified parameters (in block 470). For example, the system may determine whether the sale can cover costs of the device component, whether the device component is a commodity and readily available, whether the component may be stored in inventory with respect to the rate of depreciation for holding the component in inventory, or other factors. In some examples, the decision to provide the component to a different customer user rather than a wholesaler or broker (block 470) may help alleviate a scarcity in the market and allow customer users to maintain use of their existing device components.

In some examples, the method of selling the device component can affect the weights/biases of the second machine learning model as it determines the value/cost associated with the device component. For example, when the device component is aggregated with other components and sold as a batch, the component may be sold wholesale. When the device component is sold as an individual unit, the component may be sold wholesale or through a broker. In some examples, the value of the device component is higher when sold as an individual unit to wholesale/brokers rather than being aggregated. In some examples, the transportation costs and logistical costs may decrease the value in favor of a wholesale/batch sale. The corresponding weights of the second machine learning model may be tuned during the training phase to identify the relative values of replacement or disposal of the component in view of the logistics, transportation, and type of sale (wholesale, broker, direct to customer, etc.).

At block 470, the disposal may direct the device component to a second customer user. The identification of the second customer user may be based on various parameters, including the parameters identified in block 460. In some examples, the disposal from the customer user to a second customer user may be associated with a recommendation to replace the current component with a pre-owned component (block 430).

As an illustrative example, a particular device component may include a current first model and a future/newer generation second model. The first model may be produced and distributed to users while the second model is in preproduction. As customer users implement the first model of the component in their data environments, the second model may be released. When customer users are not ready to move from the first model to the second model, the demand for device components associated with the first model may have a higher demand spike from existing customers that are not ready to move to the second model. In some examples, the component may be stored for future reuse of the component (block 450) so that future demand from customers may be satisfied when they need it (block 430, 470).

At block 480, the disposal of the device component may provide it to a recycling program. The device component may be provided to the recycling program, for example, when the cost of replacing the component (block 410) outweighs the value of repurposing the component at a different location or decomposing the component for sub-components or other parts. In some examples, the component may only be recycled when it is a commodity component that is widely available from other locations.

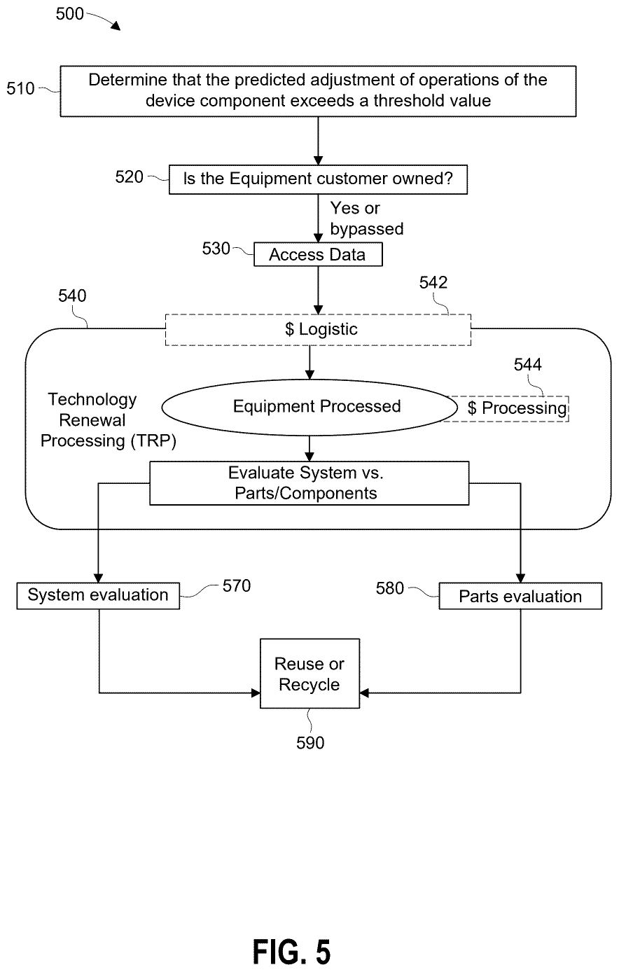

FIG. 5 is an illustrative process for evaluating computing components for predictive component management, in accordance with some examples described herein. In example 500, the system may determine physical parameters (e.g., through virtual or in-person analysis of the component) or other considerations associated with the predicted value of the computing component. The system may correspond with various systems comprising a processor and memory components, including computing component 100 illustrated in FIG. 1.

At block 510, the process may determine that the predicted adjustment of the operations of the device component exceed the threshold value. For example, the predicted adjustment of the operations (determined from the first machine learning model) may be compared with a threshold value. The threshold value may be based on historical data, industry standards, expert knowledge, or other critical level of deterioration or other adjusted operational value. In some examples, the threshold value is a specific value or relative (e.g., a percentage increase from a historical value). In some examples, the threshold value may be based on a binary classification (e.g., “deteriorated” if the prediction exceeds the threshold value and “not deteriorated” otherwise).

At block 520, the process may determine whether the device component is owned. For example, the device component may be unowned or owned. The determination of ownership may be identified from a data store that associates a particular device component with the status of the ownership, owner's information, location of the device component, or other information. When the device component is unowned, a first action may be initiated (e.g., to transmit a notification regarding replacing the device component).

The ownership of the device component may be associated with a customer user that paid for the equipment up front or via a financing option or when the equipment is included in a service or subscription model. The device component may be owned when it is not rented, financed, or otherwise unowned. When the ownership of the device component is unowned, the device component may be associated with an ongoing payment obligation to an entity, or it is rented or borrowed for a duration of time, causing the device to be unowned by the customer user.

In some examples, the ownership may be separated based on portions of the device component. For example, the ownership may correspond with the hardware of the device and the software may be unowned (e.g., as part of a service or subscription model).

In some examples, the user may acknowledge ownership of the device component. This may allow block 520 to be bypassed and the process may proceed to block 530 (e.g., to proceed with recommendations, etc.). When the device component is owned or the user has confirmed/bypassed this option, the process may proceed to block 530.

At block 530, process may access data associated with the physical features of the device component. The data may comprise a detailed list of all the component identifiers and data includes a list of the raw materials, parts, and subassemblies needed to manufacture the device component.

At block 540, the process may receive physical parameters of the device component. The physical parameters may be generated from an equipment assessment process via Technology Renewal Processing (TRP) that is conducted between the first time (e.g., when the predicted operations are on a trend that is estimated to exceed the threshold value) and the second time (e.g., when exceeding the threshold value is predicted to occur).

In some examples, the TRP can include a physical assessment or a virtual assessment (e.g., image processing). The assessment may be performed by a third party entity and the data from the assessment may be received by the system described herein, although various methods may be implemented for TRP. For example, the TRP may include an on-site assessment at the customer's location or a virtual assessment remotely from the customer's location while the device component remains at the customer's location. In some examples, the TRP may be implemented by a third party entity that accesses the physical device and provides the resulting assessment data to the system. In some examples, the TRP may be implemented via a co-location process, where the device component is located and analyzed at one location (e.g., capturing images or streaming data of the device component) and the data are provided to the system for further analysis.

In some examples, the cost associated with logistics (block 542) and the cost of inspecting/processing the device component (block 544) is incorporated to the value calculation of replacing or disposing of the device component. For example, the value may be reduced (in association with a weight/bias in the second machine learning model) for determining a replacement or disposal determination that includes logistics or processing. In some examples, the value of the device component increases when the logistics (block 542) or processing (block 544) of the device component is not implemented.

The physical parameters of the device component may be determined by analyzing the device component. The analysis may be performed by an entity in association with a TRP, either by a human analyzed that provides input to the system or via an automated process that inspects the component. The physical inspection of the component may be stored as physical parameters of the device component in a data store.

In some examples, the physical parameters may identify whether the device component is operational, non-operational, or damaged. For example, the component may not be functioning in its current state, yet may become functioning by replacing a sub-component (e.g., battery, processor in a server, power supply, etc.). In another example, the component may be damaged in its current state (e.g., cosmetic or extensive) on a scale or range of values. The correlation of the damage may be adjusted based on the scarcity of the device component (e.g., if the component is scarce, it may still be valuable on the resale market).

In some examples, the physical parameters or specifications of the device component is provided to a second machine learning model, where the output of the model comprises a predicted value of the device component associated with the physical parameters identified during the equipment assessment via the TRP.

At block 570, a system evaluation may be initiated. For example, the system evaluation may comprise a determination of the device component in its fully operational state or in sub-components/parts (block 580). In some examples, for whole systems (e.g., servers, gateways, switches, etc.), the value of the device component may be identified by an end date of support (e.g., higher value with more support time remaining or higher value with more scarcity), the value corresponding to the number of users that are required to use the device components (e.g., locked into a legacy device component absent a newer model or version), or the value associated with the market conditions (e.g., supply and demand).

In some examples, the value of the device component may be associated with current features of the device component, including age, brand/model, end of support date, number of customers currently using similar device components (e.g., cross-compatibility), number of customers that are required to continue using the component in their computing environment (e.g., difficulty to migrate to the new version), market conditions (e.g., supply/scarcity on the secondary market, average price exceeding a threshold value on the secondary market, etc.), or other factors that may affect the value of the component.

In some examples, the value of the device component may be affected by historical data, including supply of devices with the same component specifications (e.g., CPU, RAM, storage, GPU, brand, age), historical sale price, condition of the component and its effect on resale (e.g., new, used, refurbished), and market trends (e.g., seasonality, demand fluctuations). Other supply and demand factors may adjust the value of the device component as well.

At block 580, a parts evaluation may be initiated. For example, the parts evaluation may comprise a determination of the device component as its sub-components/parts (e.g., memory, processors, bolts, etc.). In some examples, the value of the device component may be identified by a demand for the part being installed in other device components (e.g., the scarcity of a GPU), the cross-compatibility of the part to work in other device components, and the cost to transport the device component to a second location to install it in the secondary device (e.g., determined by transportation module 114).

At block 590, various actions may be implemented, as described throughout the disclosure. For example, the process may initiate an action associated with disposing of the device component, including the reuse or recycling of the component. In another example, the action may correspond with transmitting a notification regarding replacing the device component with a new or pre-owned device component, disposing of the device component from the customer user to reuse it somewhere else, or other actions discussed herein.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

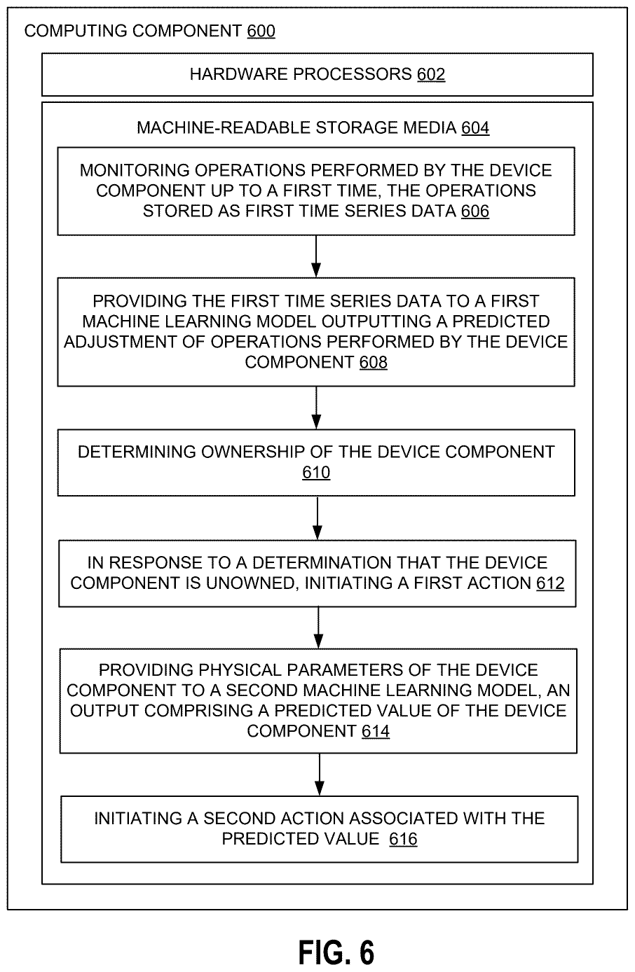

FIG. 6 illustrates a computing component that may be used to implement predictive component management with automated replacement and disposal determinations, in accordance with various examples of the disclosed technology. Referring now to FIG. 6, computing component 600 may be, for example, a server computer, a controller, or any other similar computing component capable of processing data. In the example implementation of FIG. 6, the computing component 600 includes hardware processor 602 and machine-readable storage medium 604.

Hardware processor 602 may be one or more central processing units (CPUs), graphics processing units (GPUs), semiconductor-based microprocessors, and/or other hardware devices suitable for retrieval and execution of instructions stored in machine-readable storage medium 604. Hardware processor 602 may fetch, decode, and execute instructions, such as instructions 606-616, to control processes or operations for implementing predictive component management with automated replacement and disposal determinations. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-616.

Hardware processor 602 may execute instruction 606 to monitor operations performed by a device component up to a first time. The operations may be stored as first time series data associated with the monitoring.

Hardware processor 602 may execute instruction 608 to provide the first time series data to a first machine learning model. The output of the first machine learning model may comprise a predicted adjustment of the operations performed by the device component at a second time.

Hardware processor 602 may execute instruction 610 to determine ownership of the device component at the first time. The ownership may be determined in response to the predicted adjustment of the operations exceeding a threshold value at the second time.

Hardware processor 602 may execute instruction 612 to initiate a first action associated with the monitoring and the predicted adjustment of the operations. The initiation of the first action may be in response to a determination that the device component is unowned.

Hardware processor 602 may execute instruction 614 to provide physical parameters of the device component at the first time to a second machine learning model. The physical parameters may be provided in response to a determination that the device component is owned. The output of the second machine learning model may comprise a predicted value of the device component associated with the physical parameters at the first time.

Hardware processor 602 may execute instruction 616 to initiate a second action associated with the predicted value. The second action may be initiated in response to the predicted value determined by the second machine learning model.

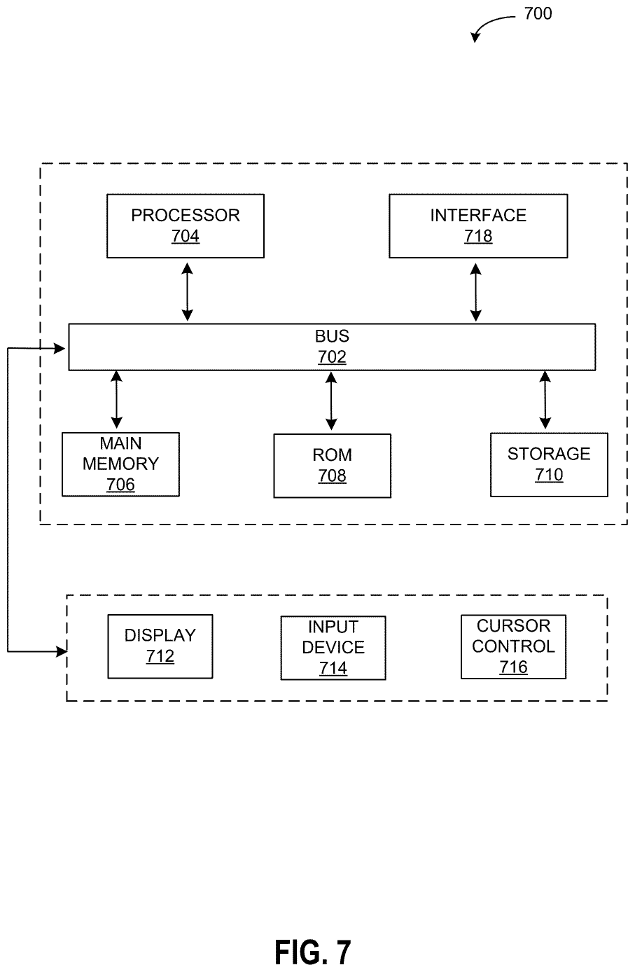

FIG. 7 depicts a block diagram of an example computer system 700 in which various examples of the disclosed technology described herein may be implemented. Computer system 700 includes bus 702 or other communication mechanism for communicating information, one or more hardware processors 704 coupled with bus 702 for processing information. Hardware processor(s) 704 may be, for example, one or more general purpose microprocessors.

Computer system 700 also includes main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes read only memory (ROM) 708 or other static storage device coupled to bus 702 for storing static information and instructions for processor 704. Storage device 710, such as a magnetic disk, optical disk, or USB thumb drive (Flash drive), etc., is provided and coupled to bus 702 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 700 may implement the techniques described herein using customized hard-wired logic, one or more ASICs or FPGAs, firmware and/or program logic which in combination with the computer system causes or programs computer system 700 to be a special-purpose machine. According to one example of the disclosed technology, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

Computer system 700 also includes interface 718 coupled to bus 702. Interface 718 provides a two-way data communication coupling to one or more network links that are connected to one or more local networks. For example, interface 718 may be an integrated services digital network (ISDN) card, cable modem, satellite modem, or a modem to provide a data communication connection to a corresponding type of telephone line. As another example, interface 718 may be a local area network (LAN) card to provide a data communication connection to a compatible LAN (or WAN component to communicate with a WAN). Wireless links may also be implemented. In any such implementation, interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 718, which carry the digital data to and from computer system 700, are example forms of transmission media.

Computer system 700 can send messages and receive data, including program code, through the network(s), network link and interface 718. In the Internet example, a server might transmit a requested code for an application program through the Internet, the ISP, the local network and interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
monitoring, by a computing component, operations performed by a device component up to a first time, the operations stored as first time series data associated with the monitoring;
providing the first time series data to a first machine learning model, an output of the first machine learning model comprising a predicted adjustment of the operations performed by the device component at a second time;
in response to the predicted adjustment of the operations exceeding a threshold value at the second time, determining, by the computing component, ownership of the device component at the first time;
in response to a determination that the device component is unowned, initiating a first action associated with the monitoring and the predicted adjustment of the operations;
in response to a determination that the device component is owned, providing, using a second machine learning model, physical parameters of the device component at the first time to the second machine learning model, an output of the second machine learning model comprising a predicted value of the device component associated with the physical parameters at the first time; and
in response to the predicted value, initiating a second action associated with the predicted value.

2. The computer-implemented method of claim 1, wherein the physical parameters of the device component are generated from an equipment assessment process via technology renewal processing (TRP) that is conducted between the first time and the second time.

3. The computer-implemented method of claim 1, wherein the first action associated with the monitoring comprises transmitting a notification regarding replacing the device component.

4. The computer-implemented method of claim 1, wherein the first action associated with the monitoring comprises restarting or tuning settings of the device component.

5. The computer-implemented method of claim 1, wherein the second action comprises transmitting a recommendation to order a new device component.

6. The computer-implemented method of claim 1, wherein the second action comprises initiating an order for a new device component or initiating a transmission of a recommendation to initiate the order for the new device component.

7. The computer-implemented method of claim 1, wherein the second action comprises initiating a recycling process of the device component.

8. The computer-implemented method of claim 1, wherein the second action comprises transmitting a recommendation or initiating a sales request for sale of the device component.

9. The computer-implemented method of claim 1, wherein the second action comprises initiating a sales request to customer that directly uses the device component.

10. The computer-implemented method of claim 1, wherein the operations performed by the device component comprise computer processor unit (CPU) or graphics processor unit (GPU) utilization up to the first time.

11. The computer-implemented method of claim 1, wherein the operations performed by the device component comprise memory usage up to the first time.

12. A computer system comprising:
a memory storing instructions; and
a processor communicatively coupled to the memory and configured to execute the instructions to:
monitor operations performed by a device component up to a first time, the operations stored as first time series data associated with the monitoring;
provide the first time series data to a first machine learning model, an output of the first machine learning model comprising a predicted adjustment of the operations performed by the device component at a second time;
in response to the predicted adjustment of the operations exceeding a threshold value at the second time, determine ownership of the device component at the first time;
in response to a determination that the device component is unowned, initiate a first action associated with the monitoring and the predicted adjustment of the operations;
in response to a determination that the device component is owned, provide physical parameters of the device component at the first time to a second machine learning model, an output of the second machine learning model comprising a predicted value of the device component associated with the physical parameters at the first time; and
in response to the predicted value, initiate a second action associated with the predicted value.

13. The computer system of claim 12, wherein the physical parameters of the device component are generated from an equipment assessment process via technology renewal processing (TRP) that is conducted between the first time and the second time.

14. The computer system of claim 12, wherein the first action associated with the monitoring comprises transmitting a notification regarding replacing the device component.

15. The computer system of claim 12, wherein the first action associated with the monitoring comprises restarting or tuning settings of the device component.

16. The computer system of claim 12, wherein the second action comprises transmitting a recommendation to order a new device component.

17. The computer system of claim 12, wherein the second action comprises initiating an order for a new device component or initiating a transmission of a recommendation to initiate the order for the new device component.

18. The computer system of claim 12, wherein the second action comprises initiating a recycling process of the device component.

19. A non-transitory computer-readable storage medium storing a plurality of instructions executable by a processor, the plurality of instructions when executed by the processor cause the processor to:
monitor operations performed by a device component up to a first time, the operations stored as first time series data associated with the monitoring;
provide the first time series data to a first machine learning model, an output of the first machine learning model comprising a predicted adjustment of the operations performed by the device component at a second time;
in response to the predicted adjustment of the operations exceeding a threshold value at the second time, determine ownership of the device component at the first time;
in response to a determination that the device component is unowned, initiate a first action associated with the monitoring and the predicted adjustment of the operations;
in response to a determination that the device component is owned, provide physical parameters of the device component at the first time to a second machine learning model, an output of the second machine learning model comprising a predicted value of the device component associated with the physical parameters at the first time; and
in response to the predicted value, initiate a second action associated with the predicted value.

20. The non-transitory computer-readable storage medium of claim 19, wherein the physical parameters of the device component are generated from an equipment assessment process via technology renewal processing (TRP) that is conducted between the first time and the second time.
